(19) United States
(12) Patent Application Publication
(10) Pub. No.: US 2009/0156350 A1
(43) Pub. Date: Jun. 18, 2009

(54) DRIVE SYSTEM FOR DUAL WHEELS, PARTICULARLY OF THE TYPE USED ON ROAD ROLLERS

(76) Inventor: Giovanni Zinzani, Faenza (IT)

Correspondence Address: BUCHANAN, INGERSOLL & ROONEY PC, POST OFFICE BOX 1404, ALEXANDRIA, VA, 22313-1404, US

(21) Appl. No.: 11/910,362

(22) PCT Filed: Apr. 1, 2005
(86) PCT No.: PCT/IT05/00179

§ 371 Date: Sep. 16, 2008

(51) Int. Cl. F16H 48/06

(52) U.S. Cl. 475/220

(57) ABSTRACT

A drive system for dual wheels of road rollers. The drive system is characterized by having a substantially T-shaped main structure housing a drive shaft substantially perpendicular to two drive and reduction devices. And each of the two devices is associated with a respective dual wheel.

### TECHNICAL FIELD

The present invention relates to a drive system for dual wheels, particularly of the type used on road rollers.

### BACKGROUND ART

Road rollers are known which, instead of a metal roller, feature a number of inflatable compacting wheels.

Machines of this type are used for producing extremely smooth road surfaces.

Road rollers normally comprise four rear drive wheels and four front direction wheels.

In a first known embodiment, each rear wheel is rotated by an independent hydraulic system, which means four independent drive systems must be provided, thus increasing production cost of the road roller.

A second known embodiment comprises a single drive system, in turn comprising an axle with a differential, and two transmissions using chains or a cascade of gears. Each transmission is able to drive one set of dual wheels. Both the above embodiments, however, are complicated and expensive.

### DISCLOSURE OF INVENTION

It is therefore a main object of the present invention to provide a dual-wheel drive system designed to eliminate the aforementioned drawbacks.

According to the present invention, there is provided a drive system for dual wheels, particularly of the type used on road rollers, as claimed in claim 1.

### BRIEF DESCRIPTION OF THE DRAWINGS

A non-limiting embodiment of the present invention will be described by way of example with reference to the accompanying drawings, in which:

FIG. 1 shows an overall side view of a road roller featuring at least one drive system in accordance with the main object of the present invention;

FIG. 2 shows a front view of the FIG. 1 road roller;

FIG. 3 shows a rear view of the FIG. 1 road roller;

FIG. 4 shows a schematic plan view of the axles of the FIG. 1-3 road roller;

FIG. 5 shows an overall view of the drive system in accordance with the main object of the present invention;

FIG. 6 shows a section, in plane α, of the FIG. 5 assembly;

FIG. 7 shows a section, in plane β, of the FIG. 5 assembly.

### BEST MODE FOR CARRYING OUT THE INVENTION

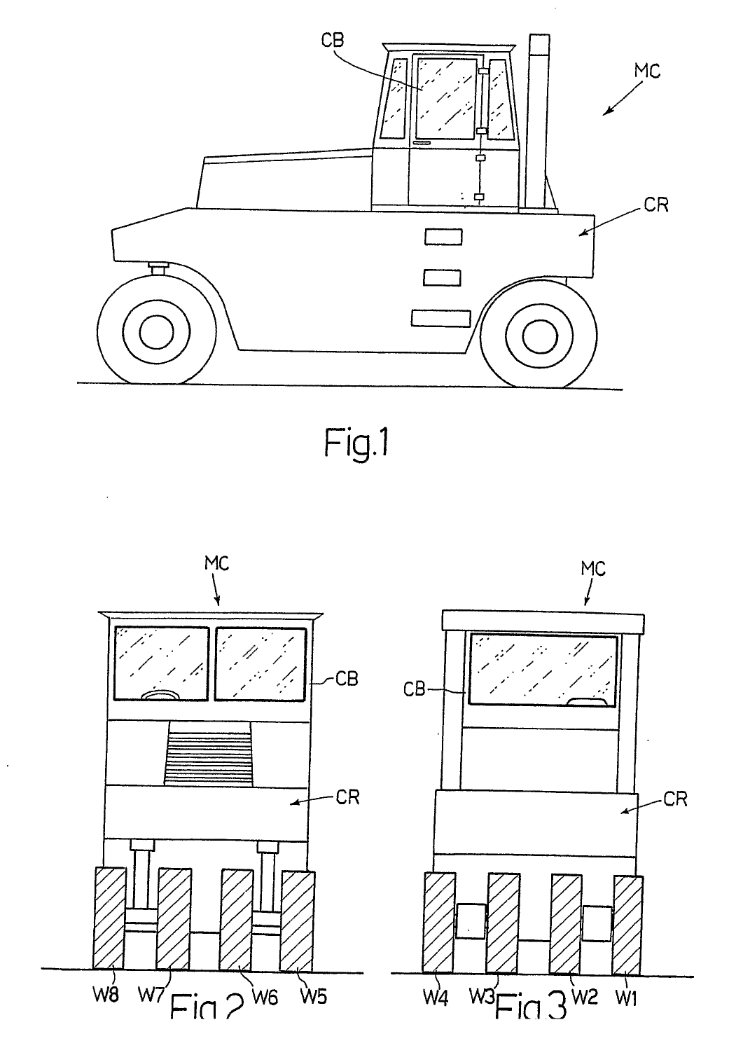

MC in FIG. 1 indicates a road roller equipped with at least one drive system in accordance with the main object of the present invention (see below).

Roller MC comprises, in known manner, a body CR comprising an operator cab CB.

As also shown in FIGS. 2, 3, 4, roller MC comprises four tyred rear wheels W1, W2, W3, W4 and four tyred front wheels W5, W6, W7, W8.

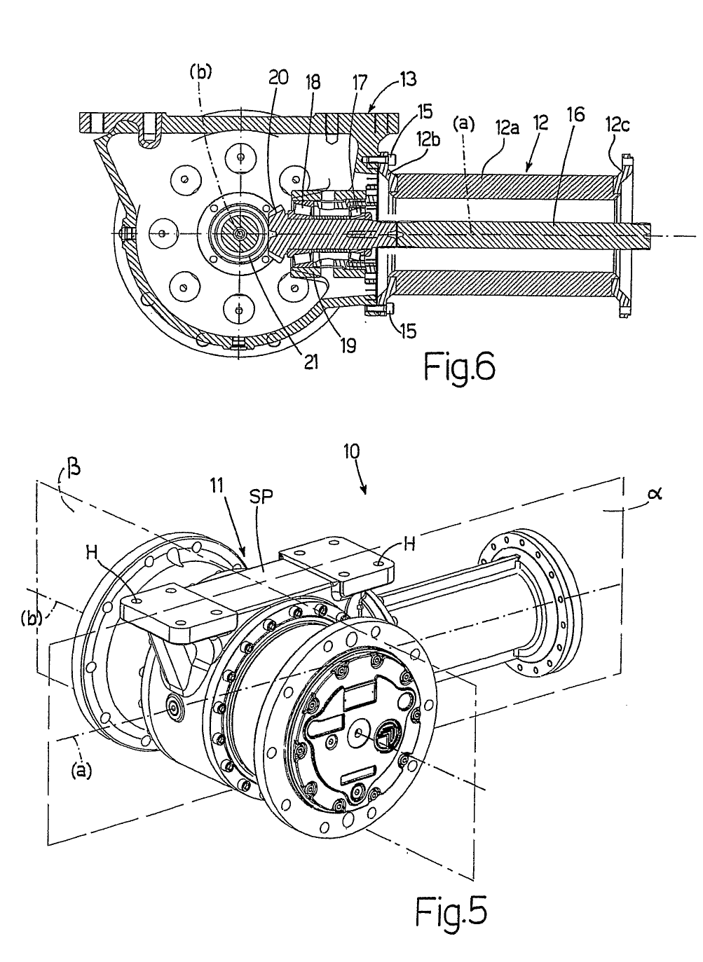

Number 10 in FIG. 5 indicates as a whole a drive system in accordance with the present invention, and which is fitted to each set of dual wheels W1, W2 and W3, W4.

Drive system 10 comprises a substantially T-shaped main structure 11.

More specifically, main structure 11 comprises a flanged sleeve 12 (FIG. 6); and a housing structure 13 housing two drive and reduction devices (see below, FIGS. 2 and 3).

As shown in FIG. 5, structure 13 is fitted integrally with a plate SP with holes H for bolts (not shown) by which to fix drive system 10 to the frame (not shown) of roller MC (FIG. 1).

As shown in FIG. 6, sleeve 12 comprises a tubular portion 12a fitted with two end flanges 12b and 12c.

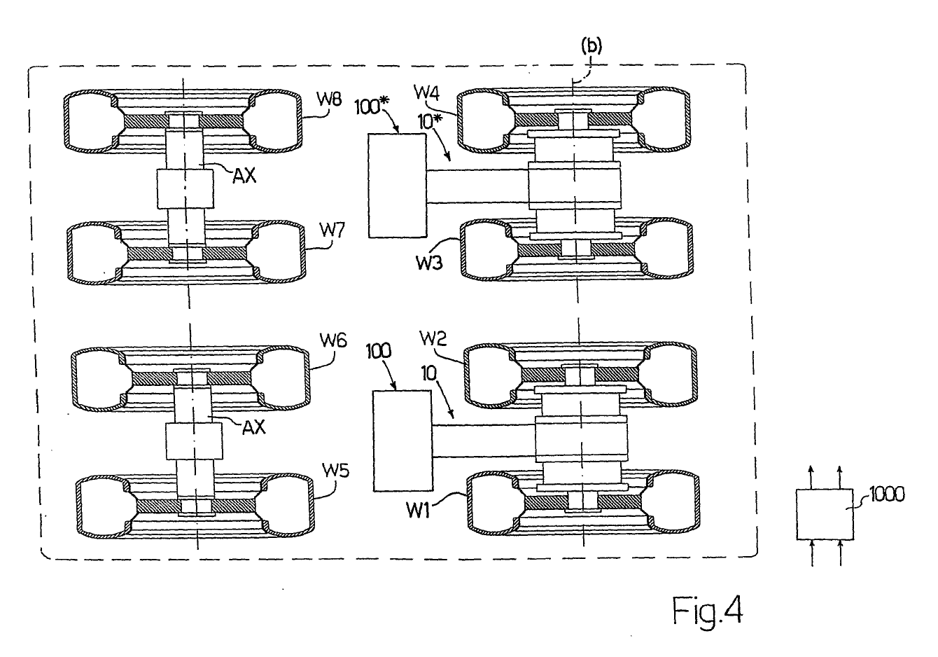

Flange 12b connects sleeve 12 to housing structure 13 by means of screws 15 (FIG. 6), while flange 12c fixes the sleeve 12 to the body of a hydraulic brake (not shown) fitted with a hydraulic motor (not shown), which rotates a drive shaft 16 (FIG. 6) for transmitting motion to a set of tyred dual wheels, e.g. W1, W2 (FIG. 4).

As shown in FIG. 6, drive shaft 16 is supported on two bearings 17, 18 in turn resting on a tubular supporting member 19 integral with structure 13.

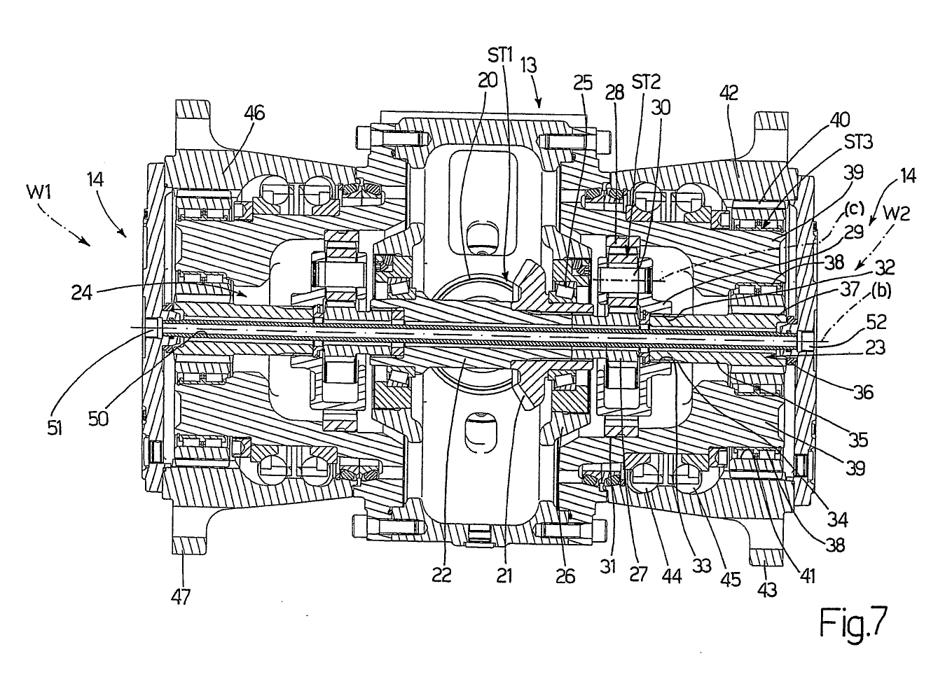

Drive shaft 16 is fitted at one end with a bevel gear 20 meshing, in use, with a ring gear 21 (FIGS. 6, 7).

As shown in FIG. 7, ring gear 21 is fitted to a shaft 22, which transmits motion to two identical drive and reduction devices 23, 24.

As shown in FIGS. 5, 6, the longitudinal axis (a) of drive shaft 16 is perpendicular to and forms a T with the longitudinal axis (b) of shaft 22.

A respective wheel W1, W2, W3, W4 (not shown in FIG. 7; see FIG. 4), is fitted by known means to each device 23, 24.

Since, as stated, both devices 23, 24 are identical, only one is described in detail below.

As will be seen, in addition to transmitting motion from drive shaft 16 to a tyred wheel (not shown in FIG. 7), device 23 also provides for reducing input speed to structure 13 by means of three reduction stages ST1, ST2, ST3.

More specifically, the first reduction stage ST1 is defined by the bevel gear 20 and ring gear 21 connection. The other two reduction stages ST2, ST3 are described in detail below.

The portion of shaft 22 relating to device 23 rests on a bearing 25 in turn supported by a support 26 integral with structure 13.

Shaft 22 is fitted with a sun gear 27 of the second reduction stage ST2, which meshes with a number of planet gears 28 (only one shown in FIG. 7); and each planet gear 28 is fitted to a planet carrier 29 by means of a respective pin 30 having an axis (c) parallel to axis (b).

In addition to sun gear 27, each planet gear 28 also meshes with a fixed ring gear 31 on the inner wall of structure 13.

To sum up, the second reduction stage ST2 comprises sun gear 27, planet gears 28, planet carrier 29, pins 30, and fixed ring gear 31.

As shown in FIG. 7, planet carrier 29 has a cavity 32 having a number of teeth 33, which mesh with splines 34 formed on a shaft 35, the free end of which rests on a thrust bearing 36. Shaft 35 is fitted with a sun gear 37 meshing with a number of planet gears 38 (only two shown in FIG. 7) fitted to a fixed planet carrier 39 forming part of housing structure 13.

In addition to meshing with sun gear 37, planet gears 38 also mesh with a ring gear 40 on the wall of a cavity 41 formed on a member 42 having a flange 43, to which a wheel W1, W2, W3, W4 is bolted.

As shown in FIG. 7, member 42 is supported on two bearings 44, 45 fitted to fixed planet carrier 39.

To sum up, the third reduction stage ST3 comprises shaft 35, sun gear 37, planet gears 38, planet carrier 39, and ring gear 40.

In other words, motion is transmitted by drive shaft 16, which rotates ring gear 21 via bevel gear 20.

The first element in the drive and reduction train to each wheel is therefore bevel gear 20, and the last is member 42 (to which, in fact, a wheel W1, W2, W3, W4 is fitted).

The same shaft 22 of device 23 transmits motion to a member 46 (and associated flange 47) of device 24, to which a wheel W1, W2, W3, W4 is fitted.

The FIG. 4 application, for example, shows two systems 10 and 10* fitted to the rear of a road roller MC (shown only partly).

In the example shown, system 10 rotates a set of dual wheels W1, W2, and system 10* a set of dual wheels W3, W4.

The embodiment in the accompanying drawings therefore shows a mechanical drive comprising at least two drive systems 10, 10* as described above.

As shown in FIG. 4, system 10 is combined with a respective hydraulic motor 100, and system 10* with a respective hydraulic motor 100*.

Since both hydraulic motors 100, 100* of the mechanical drive are connected parallel to their hydraulic control circuit, the so-called “differential effect” is produced automatically when steering road roller MC.

As shown in FIG. 4, the roller has a front axle AX.

Axle AX is fitted with four front non-drive wheels W5, W6, W7, W8 connected in pairs.

Another feature of the present invention relates to compressed-air supply to wheels W1, W2, W3, W4.

As shown in FIG. 7, a channel 50 for feeding compressed air to wheels W1, W2, W3, W4 extends along each shaft 22.

One end 51 of channel 50, corresponding to the inner side of the roller, is fitted with a rotary joint (not shown) for connection to a fixed branch of an air feed circuit (not shown); and a respective hose (not shown) extends from each end 51, 52 to feed compressed air to a tyre of a respective wheel (W1, W2 or W3, W4).

The air pressure of wheels W1, W2, W3, W4 is thus equalized.

1. A drive system (10, 10*) for dual wheels (W1, W2, W3, W4), particularly of the type used on road rollers (MC); the drive system (10, 10*) being characterized by comprising a substantially T-shaped main structure (11); said main structure (11) housing a drive shaft (16) substantially perpendicular to two drive and reduction devices (23, 24), each of said drive and reduction devices (23, 24) being associated with a respective dual wheel (W1, W2, W3, W4).

2. A drive system (10, 10*) as claimed in claim 1, characterized in that each drive and reduction device (23, 24) comprises at least two reduction stages (ST1, ST2, ST3).

3. A drive system (10, 10*) as claimed in claim 2, characterized in that a last reduction stage, (ST3) comprises a shaft (35); a sun gear (37); a number of planet gears (38); a fixed planet carrier (39); and a ring gear (40) located in a cavity (41) formed on a member (42) having a flange (43) to which a wheel (W1, W2, W3, W4) is fixed.

4. A drive system (10, 10*) as claimed in any of the foregoing claim 1, characterized in that motion is transmitted between a drive shaft (16) and said two drive and reduction devices (23, 24) via, a bevel gear (20) meshing with a ring gear (21).

5. A drive system (10, 10*) as claimed in claim 1, characterized by comprising a plate (SP) by which to fix said drive system (10) to the frame of the road roller (MC).

6. A drive system (10, 10*) as claimed in claim 1, characterized by being fitted through with a channel (50) for feeding compressed air to two tyres of two wheels (W1, W2; W3, W4).

7. A mechanical drive, characterized by comprising at least two drive systems (10, 10*) as claimed in claim 1.

8. A mechanical drive as claimed in claim 7, characterized in that, each drive system (10, 10*) comprises a respective hydraulic motor (100, 100*); each hydraulic motor (100, 100*) being connected parallel to a respective hydraulic control circuit to automatically produce a “differential effect”.

9. A mechanical drive as claimed in claim 7, characterized by being applied to the rear wheels (W1, W2, W3, W4) of a road roller (MC).
